(19) United States
(12) Patent Application Publication
(10) Pub. No.: US 2010/0235354 A1
(43) Pub. Date: Sep. 16, 2010

(54) COLLABORATIVE SEARCH ENGINE SYSTEM

(75) Inventors: Gianluca Gargaro, Rome (IT); Andrea Orestano, Rome (IT)

Correspondence Address: IBM AUSTIN IPLAW (DG), C/O DELIZIO GILLIAM, PLLC, 15201 MASON ROAD, SUITE 1000-312, CYPRESS, TX, 77433, US

(73) Assignee: International Business Machines Corporation, Armonk, NY (US)

(21) Appl. No.: 12/402,892

(22) Filed: Mar. 12, 2009

(51) Int. Cl. G06F 17/30

(52) U.S. Cl. 707/725; 707/E17.014; 707/E17.017

(57) ABSTRACT

An apparatus and method for implementing a collaborative search engine. A plurality of search tags associated with one or more search terms received from a client device associated with a user of a collaborative search engine are determined. A plurality of users of the collaborative search engine that are associated with information relevant to one or more of the search tags are identified. A time reference associated with the information associated with each of the users is determined. Search results are generated ranking the relevance of each of the plurality of users with respect to the search tags based, at least in part, on the relevance of the information associated with each of the users and the time reference associated with the information.

### BACKGROUND

Embodiments of the inventive subject matter generally relate to the field of computer systems, and, more particularly, to a collaborative search engine system.

Web-based search engines are tools used by people to search for information in the World Wide Web over a computer network, e.g., the Internet. Current search engine systems use a variety of different algorithms and techniques to rank the most relevant information found in the Web with respect to a received search query. In many cases, the search engines determine the relevance of the information by analyzing the text in the documents or the link structure of the documents found in the Web. After determining the relevance of the information, the search engines present the users search results ranking the different websites, documents, blogs, etc. in order of relevance.

### SUMMARY

Various embodiments are disclosed of an apparatus and method for implementing a collaborative search engine. In one embodiment, a plurality of search tags associated with one or more search terms received from a client device associated with a user of a collaborative search engine are determined. A plurality of users of the collaborative search engine that are associated with information relevant to one or more of the search tags are identified. A time reference associated with the information associated with each of the users is determined. Search results are generated ranking the relevance of each of the plurality of users with respect to the search tags based, at least in part, on the relevance of the information associated with each of the users and the time reference associated with the information.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram of one embodiment of a collaborative search engine system;

FIG. 2 depicts an example flow diagram of a method for performing a search using a collaborative search engine;

FIG. 3 conceptually depicts one example search result provided to a client associated with a user of the collaborative search engine;

FIG. 4 depicts an example flow diagram of a method for using search results obtained from the collaborative search engine to interact with users of the collaborative search engine; and

FIG. 5 depicts an example computer system.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

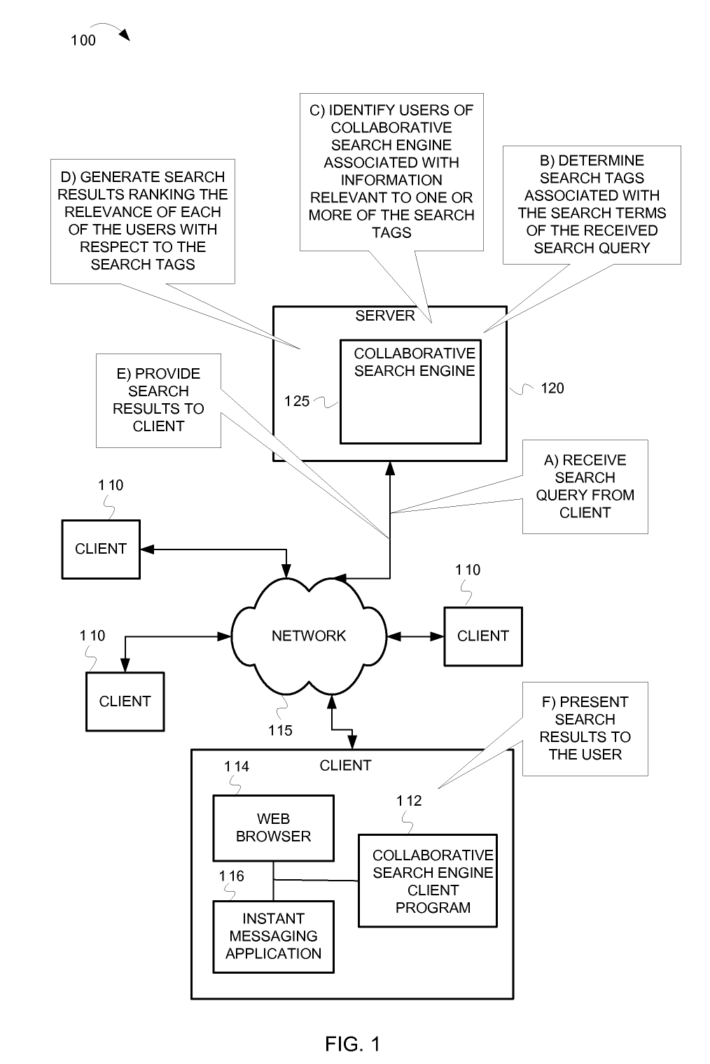

FIG. 1 is a block diagram of one embodiment of a collaborative search engine system 100. The system 100 includes a plurality of clients 110, a network 115, and a server 120. As illustrated, the server 120 comprises a collaborative search engine 125, and each of the clients 110 comprises a collaborative search engine client program 112, a web browser 114, and an instant messaging (IM) application 116. In one implementation, the server 120 may comprise a plurality of servers, databases, and other network components, which may be distributed across the network 115. In one implementation, the collaborative search engine client program 112 can be a plug-in for the web browser 114 and/or the IM application 116. It is noted, however, that in other implementations the collaborative search engine client program 112 can be a stand-alone software application.

A user of a client 110 (e.g., a desktop computer, laptop, mobile phone, etc.) can initiate a search by communicating with the collaborative search engine 125 of the server 120 via the network 115 (e.g., the Internet). The collaborative search engine 125 can perform the search by considering the knowledge (e.g., areas of expertise specified in user profiles), interactions (e.g., search history) and contributions (e.g., shared documents and links) of all the users of the collaborative search engine 125 and determining the relevance of this information, as will be further described below.

In one implementation, at stage A, the server 120 receives a search query comprising one or more search terms from a client 110 via the network 115. In one example, the user of the client 110 enters the search terms in a search box presented to the user by the collaborative search engine client 112. For example, in response to receiving a user input (e.g., via an icon or tool menu) to open the search tool, the collaborative search engine client 112 presents the search box to the user via the graphical user interface (GUI) of the web browser 114 or the IM application 116.

At stage B, the collaborative search engine 125 of the server 120 determines a plurality of search tags associated with the received one or more search terms. In one implementation, the collaborative search engine 125 determines search tags that match the search term(s), and may also determine one or more additional search tags that are related to the search term(s). For example, if the user enters the search string “traveling in New York”, the collaborative search engine 125 determines that the search tags “travel” and “New York” match the search terms “traveling” and “New York”. Also, in this example, the collaborative search engine 125 may also generate one or more additional search tags related to the search terms, such as “attractions”, “hotels”, “flights”, and “promotions”.

At stage C, the collaborative search engine 125 identifies a plurality of users of the collaborative search engine that are associated with information relevant to one or more of the search tags. In the example noted above, the collaborative search engine 125 identifies users that are associated with information relevant to the search tags “travel” and/or “New York”. The collaborative search engine 125 searches through various types of information associated with the users, e.g., search histories, shared documents, shared bookmarks, user profile information, chat histories, etc.

At stage D, the collaborative search engine 125 generates search results ranking the relevance of each of the plurality of users based on the relevance of the information associated with each of the users and a time reference associated with the information. In one implementation, the time reference is a timestamp indicating the date and time the user created, retrieved or updated the information. For example, the time reference indicates the date and time a search was performed, a document was created, a website was bookmarked, a blog was updated, an IM chat was initiated, etc. In one implementation, the relevance ranking for each of the plurality of users is determined based, at least in part, on a balance between the relevance of the information associated with each of the users and a time reference associated with the information. In one example, users associated with information relevant to both search tags “travel” and “New York” with more recent time references have a higher relevance ranking than users associated with information relevant to both search tags “travel” and New York” with older time references, and also have a higher relevance ranking than users associated with information relevant to only one of the search tags (e.g., travel).

At stage E, the server 120 provides the search results to the client 110. At stage F, the collaborative search engine client 112 presents the search result to the user via a GUI, e.g., a GUI of the web browser 114 or the IM application 116. The user then selects one of the users of the collaborative search engine 125 based on the relevance ranking provided by the search results. The user initiates an interaction with the selected user, e.g., via IM 116 or email, regarding the subject matter associated with the search, and/or views shared materials of the selected user (e.g., shared documents and bookmarks), as will be described further below.

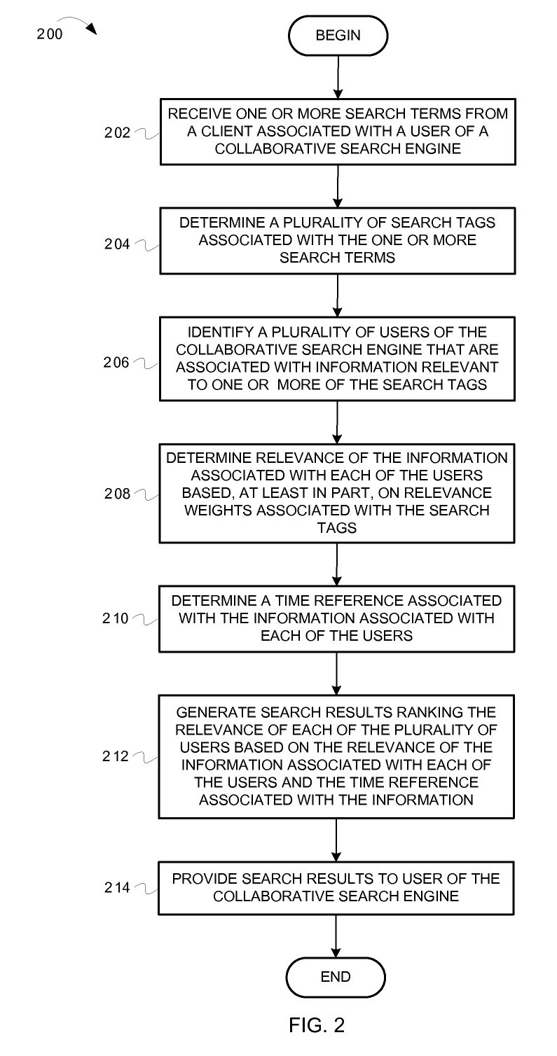

FIG. 2 depicts an example flow diagram of a method for performing a search using a collaborative search engine. The flow 200 begins at block 202.

At block 202, one or more search terms are received from a user of the collaborative search engine 125. For example, the server 120 comprising the collaborative search engine 125 receives one or more search terms from a client 110 associated with a user of the collaborative search engine 125 via the network 115 (e.g., the Internet). In a first example, the server 120 receives a search string “restaurants in Rome”, which includes the search terms “restaurants” and “Rome”. In a second example, the server 120 receives the search term “Paris”. After block 202, the flow continues at block 204.

At block 204, a plurality of search tags associated with the one or more search terms are determined. In one implementation, the collaborative search engine 125 determines search tags that match the received search term(s). In some implementations, the collaborative search engine 125 may also determine one or more additional search tags that are related to the received search term(s). In the first example noted above, the collaborative search engine 125 determines that the search tags “restaurants” and “Rome” match the received search terms. The collaborative search engine 125 may also generate one or more additional search tags related to the search terms, such as “Italian”, “French” and “Japanese”. In the second example, the collaborative search engine 125 determines that the search tag “Paris” matches the received search term. The collaborative search engine 125 may also generate one or more additional search tags related to the search term “Paris”, such as “France”, “travel”, “history”, “real estate” and “jobs”. After block 204, the flow continues at block 206.

At block 206, a plurality of users of the collaborative search engine 125 that are associated with information relevant to one or more of the search tags are identified. In the first example noted above, the collaborative search engine 125 identifies users that are associated with information relevant to the search tags “restaurants” and/or “Rome”. The collaborative search engine 125 searches through various types of information associated with the users, for example, search histories (e.g., search results and search terms used to perform specific searches), shared files (e.g., papers, articles, pictures), shared bookmarks (e.g., website and blog links), user profile information (areas of competencies and interests), history of interactions with other users (e.g., chat or IM histories), etc. In one implementation, the information associated with the users of the collaborative search engine 120 may be stored in a database associated with the server 120. For example, when a user of the collaborative search engine 125 performs a search, a record of the search, such as tag information, and search results can be stored in the database of the server 120. In some implementations, for information such as shared documents stored in the user's computer system, only tag information associated with the shared document (or other type of identifying information) may be stored in the database of the server 120 for search purposes. It is noted, however, that in other implementations the information may be stored differently, e.g. in a distributed manner across the network 115. It is further noted that each user of the collaborative search engine 125 can specify what information the user wants to share with the other users of the collaborative search engine 125, as well as other configuration options regarding the level of privacy and the level of interactivity desired by the user. For example, the user can control whether the user's IM and/or email information is shared with the other users of the collaborative search engine 125. After block 206, the flow continues at block 208.

At block 208, the relevance of the information associated with each of the users is determined based, at least in part, on relevance weights associated with the search tags. In one implementation, as a default, the collaborative search engine 125 assigns an equal relevance weight for each of the search tags that match the received search terms. In the first example noted above, a relevance weight of 0.50 (or 50%) can be initially assigned for the search tags “restaurants” and “Rome”. In this implementation, the user that initiated the search can modify the default relevance weights for the matching search tags, and may also add a relevance weight to one or more of the related search tags, e.g., within the GUI presenting the search result to the user, as will be further described below. In one implementation, to determine a relevance of the information associated with each of the users, the collaborative search engine 125 considers the number of search tags the information is relevant to, and the relevance weight of the search tags. In one example, assume the relevance weight of “Italian” is set to 0.2, “restaurants” is set to 0.4 and “Rome” is set to 0.4. In this example, if a search previously performed by a user A is relevant to “Italian”, “restaurants” and “Rome” (relevance weight=1.0), and a shared bookmark of a user B is relevant to “restaurants” and “Rome” (relevance weight=0.8), the information associated with user A is considered more relevant than the information associated with user B. Also, in this example, if a search previously performed by user B is relevant to “Italian” and “Rome” (relevance weight=0.6), and a shared bookmark of user B is relevant to “restaurants” and “Rome” (relevance weight=0.8), the shared bookmark of user B is considered more relevant than the previously performed search of user B. It is noted, however, that in some embodiments only the number of search tags the information is relevant to may be considered to determine the relevance of the information. After block 208, the flow continues at block 210.

At block 210, a time reference associated with the information associated with each of the users is determined. In one implementation, the time reference is a timestamp indicating the date and time the user created, obtained, or updated the information. The time reference can indicate how recent the information is with respect to the time the search was initiated, and therefore can be used as a measure of the “freshness” of the information. In one example, the time reference indicates the date and time a search was performed, a document was created, a website was bookmarked, a blog was updated, etc. In this implementation, the collaborative search engine 125 determines a time reference for all the information associated with the users that is relevant to one or more of the search tags. In the first example, the collaborative search engine 125 determines a time reference for all the information associated with the users that is relevant to one or more of the search tags “restaurants” and “Rome”. For example, the collaborative search engine 125 may determine that a search previously performed by user A, which is relevant to both search tags “restaurants” and “Rome”, was performed Jan. 17, 2009 at 6:38 pm, and may determine that a previous chat conversation by user B, which is relevant to the search tag “restaurants”, took place Jan. 12, 2009 at 5:02 pm. In another example, the time reference may indicate that the information was created, obtained, or updated a certain amount of time from the search time, e.g., 2 days, 6 hours, and 15 minutes from the search time. After block 210, the flow continues at block 212.

At block 212, search results are generated ranking the relevance of each of the plurality of users with respect to the search tags based on the relevance of the information associated with each of the users and a time reference associated with the information. In one implementation, the collaborative search engine 125 implements a ranking algorithm that assigns a weight to the relevance of the information associated with each of the users (see block 208) and to the time reference associated with the information (see block 210). In one specific example, the ranking algorithm can assign a 0.6 or 60% weight to the relevance of the information and a 0.4 or 40% to the time reference associated with the information to determine the relevance ranking of each of the plurality of users with respect to the search tags. It is noted, however, that the collaborative search engine 125 can implement a variety of other ranking algorithms to determine the relevance ranking of the plurality of users. After block 212, the flow continues at block 214.

At block 214, the search results are provided to the user of the collaborative search engine 125. For example, the server 120 provides the search results to the client 110 associated with the user of the collaborative search engine 125 via the network 115. In some implementations, the collaborative search engine 125 also provides IM contact information associated with each of the users included in the search results to the client 110. The collaborative search engine 125 may also provide other interactivity information along with the results, e.g., email addresses of the users included in the search results. After block 214, the flow ends.

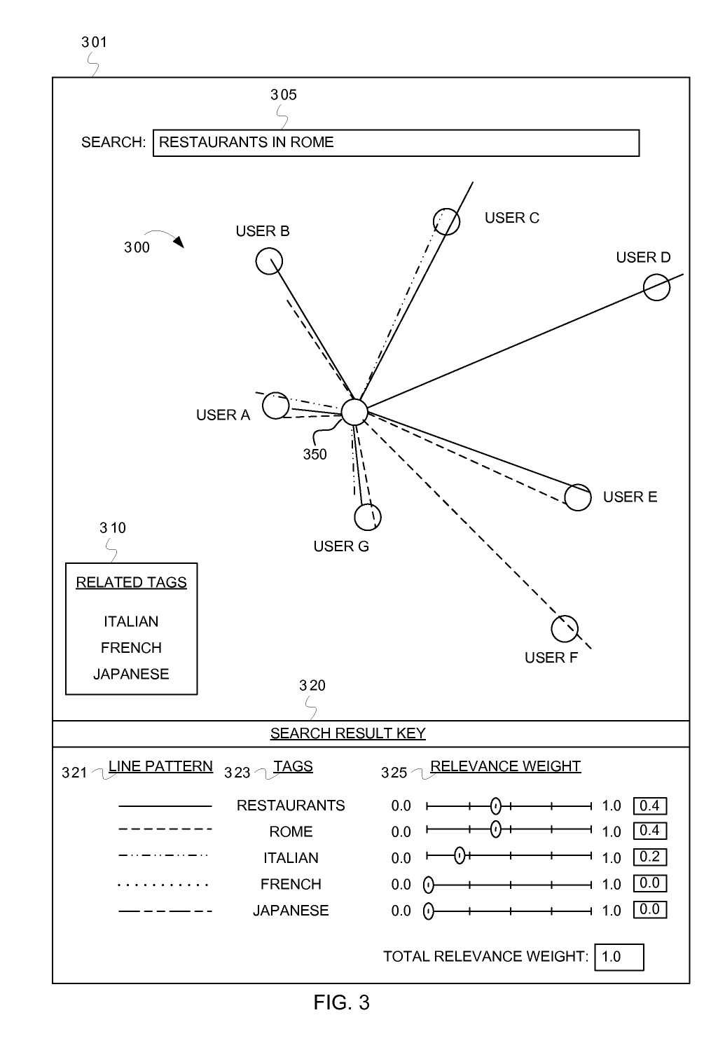

FIG. 3 conceptually depicts one example search result 300 provided to the client 110 associated with the user of the collaborative search engine 125. In the example shown in FIG. 3, the collaborative search engine client 112 presents the search result 300 to the user via a GUI 301, e.g., a GUI of the web browser 114. The GUI 301 includes a search box 305, in this example, showing the search query “restaurants in Rome” that the user entered to initiate the search. The GUI 301 also includes a related tags box 310 listing the additional search tags related to the search terms that are presented to the user. In this example, the search tags “Italian”, “French”, and “Japanese” are presented to the user as being related to the search terms “restaurants” and “Rome”. Furthermore, the GUI 301 comprises a search result key 320. The search result key 320 lists both the matching search tags “restaurants” and “Rome” and the related search tags “Italian”, “French” and “Japanese” under a search tags section 323, next to a line pattern section 321 and a relevance weight control 325. The line pattern section 321 shows the type of line pattern used in the search results 300 for each of the listed search tags. The relevance weight control 325 comprises a plurality of slide bars that allow the user to control the relevance weight for each of the listed search terms. In the example shown in FIG. 3, the relevance weight for the matching search tag “restaurants” is set to 0.4 (or 40%), the relevance weight for the matching search tag “Rome” is set to 0.4 (or 40%), and the relevance weight for the related search tag “Italian” is set to 0.2 (or 20%).

The search results 300 include a plurality of nodes that represent a plurality of users of the collaborative search engine 125, e.g., Users A-G, surrounding a center node that represents the user that initiated the search, e.g., User 350. The search results 300 include the users of the collaborative search engine 125 that are associated with information relevant to one or more of the search tags. Furthermore, the search results 300 rank the relevance of the plurality of users with respect to the search tags based on the relevance of the information associated with each of the users and the time reference associated with the information. In the example of FIG. 3, the closer the user nodes are to the center node, the more relevant the user is with respect to the search tags. For example, the search results 300 indicate that User C is ranked higher in relevance than User D, and that User A has the highest relevance rank out of all of the users. The lines that extend from the User 350 to each of the respective Users A-G indicate which search tags the information associated with the users is related to, based on the type of line pattern (see the search results key 315). In the example shown in FIG. 3, the information associated with the User A is relevant to the “restaurant”, “Rome” and “Italian” search tags, and the information associated with the User F is relevant to only the “Rome” search tag. The length each of the lines is proportional to the freshness of the information; in other words, the length of each line indicates how recent the time reference associated with the information is with respect to the time the search was initiated. In this example, the shorter the length of the line, the more recent the time reference associated with the information is with respect to the search time.

In some implementations, when the user of the collaborative search engine 125 modifies the relevance weights associated with the search tags via the relevance weight control 325, the collaborative search engine 125 updates the search results 300 based on the new relevance weights. The new relevance weights may cause certain user nodes to move farther away from or closer to the center node in the updated search results. Furthermore, in some implementations, the user nodes corresponding to Users A-G may indicate whether the user is available or unavailable via IM. For example, the user node may be green in color when the user is available via IM or may be red in color when the user is unavailable via IM.

It is noted that in other implementations the search results received at the client 110 from the collaborative search engine 125 can be presented to the user in a variety of other formats that rank the relevance of a plurality of users with respect to the search tags. For example, the search results can be presented to the user in a bar graph format or in a graph with x and y coordinates. In another example, the search results can be presented in a chart listing the users in order of relevance, along with other information, such as the relevance of the information associated with each user and the time reference associated with the information.

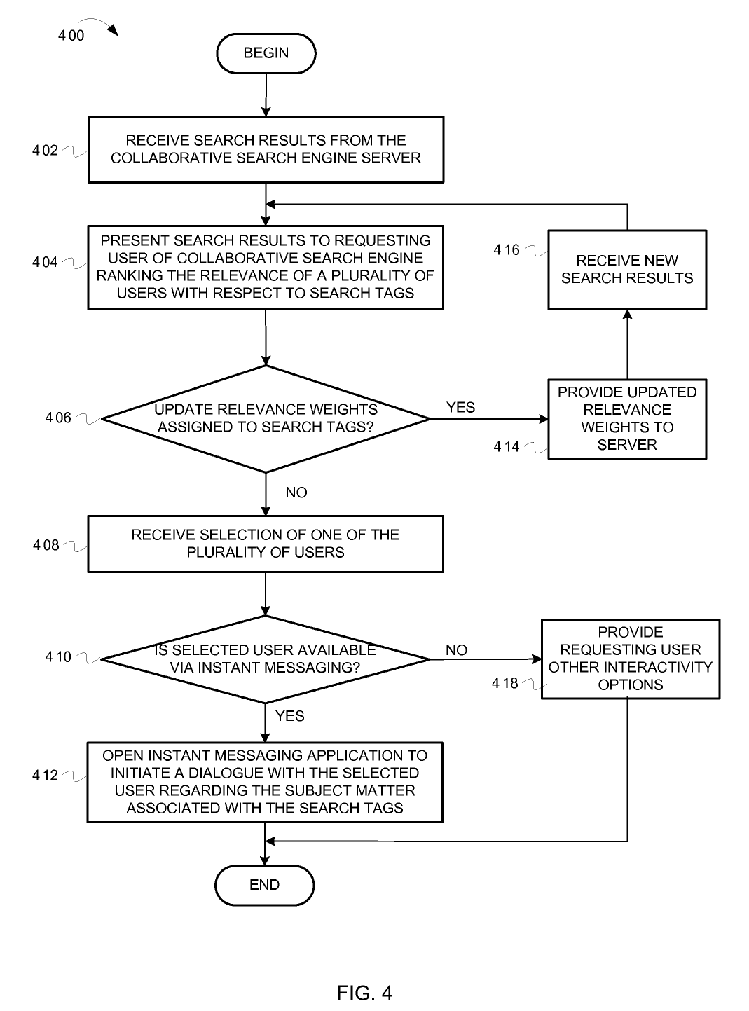

FIG. 4 depicts an example flow diagram of a method for using search results obtained from the collaborative search engine 125 to interact with users of the collaborative search engine 125. The flow 400 begins at block 402.

At block 402, the search results are received from the server 120 comprising the collaborative search engine 125. For example, the client 110 associated with the user of the collaborative search engine 125 that initiated the search (i.e., the requesting user) receives the search results, e.g., the search results described above with reference to FIGS. 2-3. After block 402, the flow continues at block 404.

At block 404, the search results are presented to the requesting user of the collaborative search engine 125. As described above, the search results rank the relevance of a plurality of users of the collaborative search engine 125 with respect to the search tags based on the relevance of the information associated with each of the users and the time reference associated with the information. In some implementations, the relevance of the information associated with each of the users can be determined based, at least in part, on relevance weights assigned to each of the search tags. In one example, the collaborative search engine client program 112 presents the search results to the requesting user via a GUI on a display of the client 110. After block 404, the flow continues at block 406.

At block 406, it is determined whether an input is received from the requesting user to update the relevance weights assigned to the search results. In one example, the collaborative search engine client program 112 can receive an input from the requesting user to increase the relevance weight of one or more search tags and decrease the relevance weight of one or more search tags, e.g., via the relevance weight control 325 shown in FIG. 3. If the collaborative search engine client program 112 does not receive an input from the requesting user to update the relevance weights, the flow continues at block 408. Otherwise, the flow continues at block 414.

At block 408, a selection of one of the plurality of users is received. For example, the collaborative search engine client 112 receives a selection of one of the plurality of users included in the search results 300 from the requesting user. For instance, in the example shown in FIG. 3, the requesting user selects one of the nodes representing the plurality of users in the search results 300.

At block 410, it is determined whether the selected user is available via instant messaging (IM). For example, when presenting the search results to the requesting user, the collaborative search engine client 112 obtains information from the IM application 116 regarding whether each of the users is available via IM. As described above in the example of FIG. 3, the color of each of the user nodes can indicate the availability of each of the users to the requesting user, e.g., a green user node indicates that the user is available and a red user node indicates the user is not available. If the selected user is available via IM, the flow continues at block 412. Otherwise, the flow continues at block 418.

At block 412, the IM application 416 is opened to contact the selected user. In one example, the IM application 416 is opened when the user is selected, e.g., by double-clicking the corresponding user node in the search results. The requesting user can utilize the IM application 416 to initiate a live interaction with the selected user to discuss the subject matter associated with the search tags. By selecting a user that is ranked as one of the most relevant users in the search results with respect to the search tags, the requesting user increases the likelihood that the selected user will be interested in discussing the subject matter associated with the search tags. After block 412, the flow ends.

At block 414, if the collaborative search engine client 112 receives an input from the requesting user to update the relevance weights, the collaborative search engine client 112 provides the updated relevance weights to the server 120. The collaborative search engine 125 generates new search results (as described above) based on the updated relevance weights and provides the new search results to the client 110. After block 414, the flow continues at block 416.

At block 416, the new search results are received at the client 110. After block 416, the flow loops back to block 404, where the collaborative search engine client 112 presents the new search results to the requesting user.

At block 418, if the selected user is not available via IM, the collaborative search engine client 112 provides the requesting user other interactivity options to initiate a dialogue with the selected user. For example, the collaborative search engine client 112 can open an email tool that allows the requesting user to send an email to the selected user without revealing the email address of the selected user. In this example, after the user enters the email message, the collaborative search engine client 112 may send the email message directly to the selected use, or may send the message to the server 120, which then forwards the message to the selected user. In another example, the collaborative search engine client 112 may provide the email address of the selected user to the requesting user. Also, the collaborative search engine client 112 may provide the requesting user the option to open the IM application 116 so the requesting user can send the selected user an offline message.

Whether or not the requesting user decides to start a dialogue with the selected user, the requesting user can access shared documents, bookmarks, and other information the selected user has shared with the users of the collaborative search engine 125. In one implementation, when the requesting user selects one of the users shown in the search results, the collaborative search engine client 112 may provide the requesting user interactivity options to initiate a dialogue with the selected user and also an option to access shared information of the selected user. When the requesting user selects (e.g., double-clicks) the option to access the shared information of the selected user, the collaborative search engine client 112 may request the shared information from the server 120. In another example, the collaborative search engine 125 may provide at least some of the shared information to the client 110 when it sends the search results, e.g., shared bookmarks. After block 418, the flow ends.

In various embodiments, users of the collaborative search engine 125 register with the server 120 to obtain a user ID and an account ID to be able to share information via the collaborative search engine 125. Registered users can use a GUI associated with the collaborative search engine client program 112 (e.g., GUI 301) to designate certain information as shared information. For example, a registered user can designate a document the user created, an article the user found via the Internet, and/or various bookmarks as shared information. Furthermore, registered users can specify whether searches the user performs on the collaborative search engine 125 or IM conversation the user participates in are shared via the collaborative search engine 125. In one example, for search purposes, the shared information is associated with a registered user via the user ID and/or account ID. It is noted, however, that in other embodiments the shared information may be associated with a registered user via other identifying information, e.g., email address or IM information. In some embodiments, both registered and unregistered users can perform searches via the collaborative search engine 125. In other embodiments, only registered users can perform searches via the collaborative search engine 125.

It should be understood that the depicted flow diagrams (FIGS. 2 and 4) are examples meant to aid in understanding embodiments and should not be used to limit embodiments or limit scope of the claims. Embodiments may perform additional operations, fewer operations, operations in a different order, operations in parallel, and some operations differently. For instance, in FIG. 2, in some implementations, to determine the relevance of the information associated with each of the users, the collaborative search engine 125 may consider the amount of information (e.g., the number of past searches, the number of shared documents, the number of past chats or other interactions, etc.) associated with each of the search tags, along with the relevance weight and the number of relevant search tags. In another example, in FIG. 4, the collaborative search engine 125 and/or the corresponding client program 112 may provide interactivity options to the requesting user at the client 110 via a web interface.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

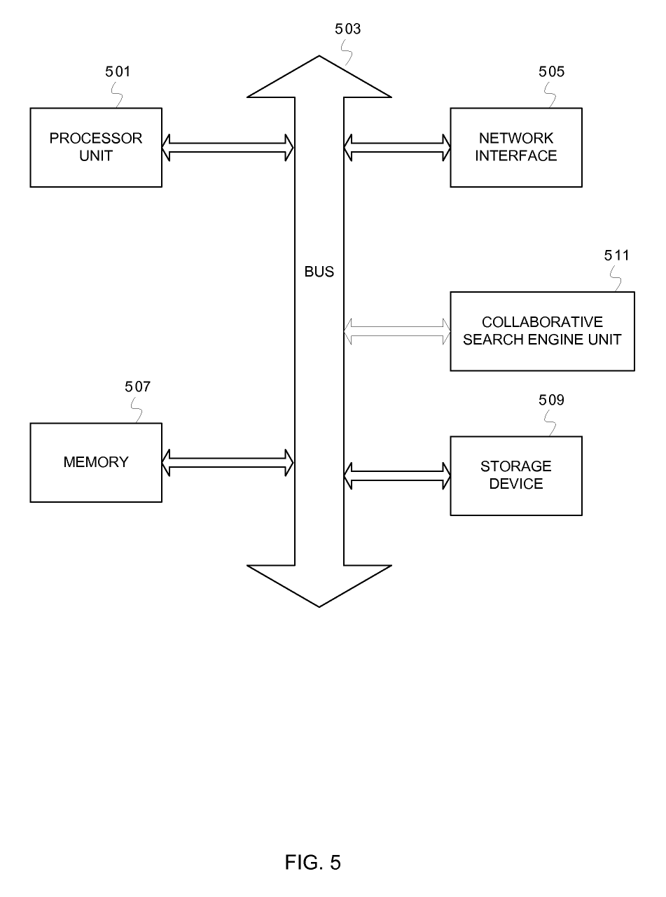

FIG. 5 depicts an example computer system. A computer system includes a processor unit 501 (possibly including multiple processors, multiple cores, multiple nodes, and/or implementing multi-threading, etc.). The computer system includes memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The computer system also includes a collaborative search engine unit 511. In some embodiments, e.g., when the computer system is a server system, the collaborative search engine unit 511 is operable to implement the search methods described above with reference to FIGS. 1 and 2. In other embodiments, e.g., when the computer system is a client system, the collaborative search engine unit 511 is operable to implement the techniques described above with reference to FIG. 4. Any one of these functionalities may be partially (or entirely) implemented in hardware and/or on the processing unit 501. For example, the functionality may be implemented with an application specific integrated circuit, in logic implemented in the processing unit 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501, the storage device(s) 509, and the network interface 505 are coupled to the bus 503. Although illustrated as being coupled to the bus 503, the memory 507 may be coupled to the processor unit 501.

While the embodiments are described with reference to various implementations and exploitations, it will be understood that these embodiments are illustrative and that the scope of the inventive subject matter is not limited to them. In general, techniques for implementing a collaborative search engine as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a plurality of search tags associated with one or more search terms received from a client device associated with a user of a collaborative search engine;
identifying a plurality of users of the collaborative search engine that are associated with information relevant to one or more of the search tags;
determining a time reference associated with the information associated with each of the users; and
generating search results ranking a relevance of each of the plurality of users with respect to the search tags based, at least in part, on a relevance of the information associated with each of the users and the time reference associated with the information.

2. The method of claim 1, further comprising determining the relevance of the information associated with each of the users based, at least in part, on a number of search tags associated with the information and relevance weights assigned to the search tags.

3. The method of claim 2, further comprising providing the client device the search results, the search tags associated with the received search terms, and the relevance weights assigned to the search tags.

4. The method of claim 3, further comprising:
receiving updated relevance weights from the client device modifying the relevance weights of at least a subset of the search tags;
generating new search results based, at least in part, on the updated relevance weights; and
providing the new search results to the client device associated with the user of the collaborative search engine.

5. The method of claim 2, further comprising assigning default relevance weights to each of the search tags, wherein said assigning default relevance weights comprises assigning equal relevance weights to each of the search tags.

6. The method of claim 1, wherein said determining a plurality of search tags associated with one or more search terms comprises determining one or more search tags that match the one or more search terms.

7. The method of claim 6, further comprising determining one or more additional search tags that are related to the one or more search terms.

8. The method of claim 1, further comprising:
determining instant messaging contact information associated with the plurality of users included in the search results; and
providing the search results and the instant messaging contact information associated with the plurality of users to the client device.

9. A method comprising:
determining a plurality of search tags associated with one or more search terms received from a client device associated with a user of a collaborative search engine;
identifying a plurality of users of the collaborative search engine that are associated with information relevant to one or more of the search tags;
determining a relevance of the information associated with each of the users based, at least in part, on relevance weights associated with the search tags;
determining a time reference associated with the information associated with each of the users;
generating search results ranking a relevance of each of the plurality of users with respect to the search tags based, at least in part, on the relevance of the information associated with each of the users and the time reference associated with the information;
determining instant messaging contact information associated with the plurality of users included in the search results; and
providing the search results and the instant messaging contact information associated with the plurality of users to the client device.

10. The method of claim 9, wherein said determining a relevance of the information comprises determining a relevance of the information associated with each of the users based, at least in part, on a number of search tags associated with the information and relevance weights associated with the search tags.

11. The method of claim 10, further comprising providing the client device the search results, the search tags associated with the received search terms, and the relevance weights associated with the search tags.

12. The method of claim 11, further comprising:
receiving updated relevance weights from the client device modifying the relevance weights of at least a subset of the search tags;
generating new search results based, at least in part, on the updated relevance weights; and
providing the new search results to the client device associated with the user of the collaborative search engine.

13. One or more machine-readable media having stored therein a program product, which when executed a set of one or more processor units causes the set of one or more processor units to perform operations that comprise:
determining a plurality of search tags associated with one or more search terms received from a client device associated with a user of a collaborative search engine;
identifying a plurality of users of the collaborative search engine that are associated with information relevant to one or more of the search tags;
determining a time reference associated with the information relevant to one or more of the search tags; and
generating search results ranking a relevance of each of the plurality of users with respect to the search tags based, at least in part, on a relevance of the information associated with each of the users and the time reference associated with the information.

14. The machine-readable media of claim 13, wherein the operations further comprise determining the relevance of the information associated with each of the users based, at least in part, on a number of search tags associated with the information and relevance weights assigned to the search tags.

15. The machine-readable media of claim 14, wherein the operations further comprise providing the client device the search results, the search tags associated with the received search terms, and the relevance weights assigned to the search tags.

16. The machine-readable media of claim 15, wherein the operations further comprise:
receiving updated relevance weights from the client device modifying the relevance weights of at least a subset of the search tags;
generating new search results based, at least in part, on the updated relevance weights; and
providing the new search results to the client device associated with the user of the collaborative search engine.

17. An apparatus comprising:
a set of one or more processing units;
a network interface; and
a collaborative search engine unit operable to,
determine a plurality of search tags associated with one or more search terms received from a client device associated with a user of a collaborative search engine;
identify a plurality of users of the collaborative search engine that are associated with information relevant to one or more of the search tags;
determine a time reference associated with the information relevant to one or more of the search tags; and
generate search results ranking a relevance of each of the plurality of users with respect to the search tags based, at least in part, on a relevance of the information associated with each of the users and the time reference associated with the information.

18. The apparatus of claim 17, wherein the collaborative search engine unit is further operable to determine the relevance of the information associated with each of the users based, at least in part, on a number of search tags associated with the information and relevance weights assigned to the search tags.

19. The apparatus of claim 18, wherein the collaborative search engine unit is further operable to provide the client device the search results, the search tags associated with the received search terms, and the relevance weights assigned to the search tags.

20. The apparatus of claim 19, wherein the collaborative search engine unit is further operable to:
receive updated relevance weights from the client device modifying the relevance weights of at least a subset of the search tags;
generate new search results based, at least in part, on the updated relevance weights; and
provide the new search results to the client device associated with the user of the collaborative search engine.
